(19) United States
(12) Patent Application Publication
(10) Pub. No.: US 2005/0154859 A1
(43) Pub. Date: Jul. 14, 2005

(54) Branch prediction in a data processing apparatus

(75) Inventor: Paul Anthony Gilkerson, Cambridge (GB)

Correspondence Address: NIXON & VANDERHYE, PC, 1100 N GLEBE ROAD, 8TH FLOOR, ARLINGTON, VA, 22201-4714, US

(73) Assignee: ARM LIMITED, Cambridge (GB)

(21) Appl. No.: 10/756,762

(22) Filed: Jan. 14, 2004

(51) Int. Cl. G06F 9/30

(52) U.S. Cl. 712/207; 712/239

(57) ABSTRACT

The present invention provides a data processing apparatus and method for predicting the execution of an instruction flow changing instruction. The data processing apparatus has a processor operable to execute instructions, and a prefetch unit operable to prefetch instructions from a memory prior to sending those instructions to the processor for execution. The prefetch unit is operable to determine for a prefetched instruction whether that prefetched instruction is an instruction flow changing instruction, and based thereon to determine a fetch address for a next instruction to be prefetched by the prefetch unit. A return stack is also provided which is accessible by the prefetch unit and operable to hold one or more addresses. Prediction logic is provided which is operable, if the prefetched instruction is a conditional instruction, to predict whether that prefetched instruction will be executed by the processor, the prefetch logic being operable to determine the fetch address dependent on the prediction from the prediction logic. In the event that the prefetched instruction is a first type of instruction flow changing instruction and is conditional, and if the prediction logic predicts that that prefetched instruction will be executed, the prefetch logic is operable to determine as the fetch address an address obtained from the return stack. By this approach, the prefetch unit is able to provide an effective prediction for instruction flow changing instructions of the first type, and further can predict the fetch address in instances where that first type of instruction flow changing instruction is predicted to be executed.

### BACKGROUND OF THE INVENTION

1. Field of the Invention

The present invention relates to a data processing apparatus and method for predicting execution of instructions.

2. Description of the Prior Art

A data processing apparatus will typically include a processor for executing instructions. Further, a prefetch unit will typically be provided for prefetching instructions from memory that are required by the processor, with the aim of ensuring that the processor has a steady stream of instructions to execute, thereby aiming to maximise the performance of the processor.

Sequences of instructions to be executed by the processor are often not stored in memory one after the other, since software execution often involves changes in instruction flow that cause the processor to move between different sections of code dependent on the tasks being executed. An example of a change in instruction flow that can occur when executing software is a “branch”, which results in the instruction flow jumping to a particular section of code as specified by the branch. A branch instruction will typically be provided which when executed will cause that branch to take place. However, often such branch instructions are conditional instructions, and as such a decision will be made by the processor as to whether to execute such a conditional instruction dependent on predetermined conditions existing at the time that that instruction is to be executed.

Conditional instructions can cause problems for the prefetch unit, since the instruction that should be prefetched by the prefetch unit will depend on whether the conditional instruction is going to be executed or not by the processor. To assist the prefetch unit in its task of retrieving instructions for the processor, prediction logic is often provided for predicting whether conditional instructions will be executed by the processor. Considering the example of a conditional branch instruction, the prediction logic may be arranged to predict whether the branch specified by that branch instruction will be taken. If the prediction logic predicts that the branch will be taken (i.e. the branch instruction will be executed), then it instructs the prefetch unit to retrieve the instruction that is specified by the branch, and clearly if the branch prediction is accurate, this will serve to increase the performance of the processor, since at the time of execution it will not need to stall its execution flow while that instruction is retrieved from memory. Typically, a record will be kept of the address of the instruction that would be required if the prediction made by the prediction logic was wrong, such that if the processor subsequently determines that the prediction was wrong, the prefetch unit can then retrieve the required instruction.

A branch instruction is an example of an instruction flow changing instruction. Whilst prediction logic is useful in predicting whether a conditional instruction flow changing instruction will be executed, this is only useful if the prefetch unit is able to determine the address (also referred to herein as the target address) in memory from which the next instruction should be retrieved if the prediction logic predicts that that instruction flow changing instruction will be executed. Hence, whilst it is known to provide prefetch units with prediction logic which can provide predictions for conditional direct branch instructions (i.e. branch instructions where the target address is specified directly within the branch instruction with reference to a program counter (PC) value), it is less common for a prefetch unit to provide predictions for conditional indirect branch instructions (i.e. branch instructions where the target address is not directly specified within the branch instruction, and instead, for example, may be specified with reference to the contents of one or more registers), since the prefetch unit often will not have access to the information required to determine the target address. Instead, such conditional indirect branch instructions are often ignored by the prefetch unit, and instead the prefetch unit merely continues to fetch instructions from an incremented PC value. If the processor subsequently executes such an indirect branch instruction, then it will typically issue a signal back to the prefetch unit to cause the prefetch unit to prefetch the next instruction required by the processor from an address specified by the processor, the processor having access to the registers, and hence being able to determine the required address for that next instruction.

One example where an unconditional indirect branch instruction has had a prediction of its target address made by the prefetch unit is in the ARM 10 processor developed by ARM Limited, where an unconditional procedure return instruction had its target address predicted with reference to a single address register maintained by the prefetch unit identifying a target address.

In addition to normal conditional branch instructions, there are other types of conditional instruction flow changing instructions which are not typically considered as branches. As an example, certain branch instructions may cause the flow of execution to branch to a particular procedure or sub-routine, and once that procedure has been executed, instruction flow then returns to the next instruction following the original branch instruction. To cause the return to take place, a procedure return instruction can be executed in order to change the value of the program counter to a return address value, so as to cause execution to return to the appropriate point, i.e. the instruction immediately following the original branch instruction. The required return address value for the instruction to be returned to will typically have been stored within a register, or stored out to memory with a pointer to that return address value in memory then being stored within a register. There are a variety of formats of such procedure return instructions, for example move instructions, load instructions, add instructions, etc, but they all typically involve updating the PC value with a return address value obtained with reference to a register and/or memory.

Such procedure return instructions are a type of instruction flow changing instruction, since they cause the PC value to be changed, but they are not typically considered to be branch instructions and hence they are not typically reviewed by the prefetch unit, or predicted by the prediction logic, particularly when in conditional form. Furthermore, it can be seen that since they typically cause the PC value to be updated with reference to the register and/or memory, they are an indirect instruction flow changing instruction, and as such the prefetch unit would typically be unable to calculate the return address. Hence, such conditional instruction flow changing instructions have not been considered by the prefetch unit and instead the prefetch unit has merely continued to fetch the next instruction from an incremented PC value.

When branch instructions that specify a branch to a particular procedure or sub-routine are executed, it is known to provide a return stack in which a return address can be specified. Typically, such a return stack is maintained by the processor. When the processor is then to execute an instruction flow changing instruction of the type where the PC value is updated with reference to the contents of a register and/or memory, then the return stack can be used to predict the new PC value prior to it actually being determined by the processor so as to allow an early indication of the address to be provided to the prefetch unit. It will be appreciated that this may provide an accurate address in situations where the instruction flow changing instruction is in fact the procedure return instruction associated with that earlier branch instruction. This approach is used for such instruction flow changing instructions when they are unconditional, since it is then certain that the processor will be executing the instruction, and accordingly it is worth making the prediction with regards to the contents of the return stack.

It is an object of the present invention to provide an improved technique for predicting execution of conditional instruction flow changing instructions.

### SUMMARY OF THE INVENTION

Viewed from a first aspect, the present invention provides a data processing apparatus, comprising: a processor operable to execute instructions; a prefetch unit operable to prefetch instructions from a memory prior to sending those instructions to the processor for execution, the prefetch unit being operable to determine for a prefetched instruction whether that prefetched instruction is an instruction flow changing instruction, and based thereon to determine a fetch address for a next instruction to be prefetched by the prefetch unit; a return stack accessible by the prefetch unit and operable to hold one or more addresses; and prediction logic operable, if the prefetched instruction is a conditional instruction, to predict whether that prefetched instruction will be executed by the processor, the prefetch logic being operable to determine the fetch address dependent on the prediction from the prediction logic; in the event that the prefetched instruction is a first type of instruction flow changing instruction and is conditional, and the prediction logic predicts that that prefetched instruction will be executed, the prefetch logic being operable to determine as the fetch address an address obtained from the return stack.

In accordance with the present invention, a data processing apparatus has a processor operable to execute instructions, and a prefetch unit for prefetching instructions from memory prior to sending those instructions to the processor for execution. Further, prediction logic is provided to predict whether a conditional prefetched instruction will be executed, with the prefetch logic determining a fetch address for a next instruction dependent on that prediction. Further, a return stack is provided which is accessible by the prefetch unit and operable to hold one or more addresses. Then, in the event that the prefetched instruction is a first type of instruction flow changing instruction and is conditional, and the branch prediction logic predicts that that prefetched instruction will be executed, the prefetch logic is operable to determine as the fetch address an address obtained from the return stack.

By this approach, the prediction logic can provide a prediction about the execution of a first type of instruction flow changing instruction that is conditional. Furthermore, even if the first type of instruction flow changing instruction is an indirect instruction flow changing instruction (i.e. the new PC value following execution of the instruction flow changing instruction is not derivable directly from the instruction flow changing instruction itself), the prefetch unit is able to establish a predicted address for a next instruction to be prefetched with reference to the contents of the return stack.

It will be appreciated that in the present context the term “next” instruction is a reference to the next instruction to be prefetched by the prefetch unit following analysis of the prefetched instruction under consideration, and does not imply that in the interim period no other instructions will have been prefetched. Indeed, it will typically be the case that whilst the prefetch unit is analysing a particular prefetched instruction, one or more other instructions may be in the process of being prefetched from the memory, and accordingly the next instruction as referred to above refers to the next instruction to be prefetched as a result of the analysis of a current prefetched instruction.

In the context of the present application, the term “executed” as used in connection with a conditional instruction refers to the actual execution of the instruction following a determination having been made by the processor that the conditions associated with that instruction have been met. It will be appreciated that a conditional instruction will typically have to be at least partially decoded by the processor in order to enable the conditional information contained in that instruction to be derived and then analysed. However, for the purposes of the present application, this process is not considered to be execution of the conditional instruction, and execution of the conditional instruction will only be considered to occur if the conditions specified by the instruction have been met. If the conditions specified by the instruction are not met, the conditional instruction is considered as not being executed.

It will be appreciated that the first type of instruction flow changing instruction may take a variety of forms. However, in one embodiment, the first type of instruction flow changing instruction is a procedure return instruction operable when executed to cause the processor to return from a procedure being executed by the processor. Hence, assuming any conditions associated with this procedure return instruction are met, and hence the procedure return instruction is executed, this will cause the processor to return from the procedure being executed by the processor. However, if any conditions associated with the procedure return instruction are not met, then no return from the procedure will take place, and instead the next sequential instruction from memory will be executed. In many existing systems, such procedure return instructions are not conditional. However, in accordance with embodiments of the present invention, such procedure return instructions can be conditional, and the prediction logic can be arranged to predict whether such conditional procedure return instructions will be executed. In the event that the prediction logic predicts that the procedure return instruction will be executed, the prefetch unit can prefetch an instruction which is predicted to be the required instruction following the return from the procedure, the address for this instruction being identified with reference to the content of the return stack.

It will be appreciated that there are a number of different ways in which addresses may be added to the return stack. However, in one embodiment, if the prefetch logic determines that the prefetched instruction is a second type of instruction flow changing instruction, the prefetch logic is further operable to determine a return address and to cause that return address to be placed on the return stack.

The prefetch logic may determine the return address in a variety of ways. However, typically, the return address will be calculated by incrementing the address of the prefetched instruction currently being analysed by the prefetch logic.

In one particular embodiment, the second type of instruction flow changing instruction is a branch with link instruction, which is operable to identify a start address for a procedure to be executed by the processor, upon returning from the procedure the next instruction to be executed by the processor being specified by the return address. In such embodiments, the procedure is typically returned from by execution of one of the first type of instruction flow changing instructions. Hence, in accordance with such embodiments of the present invention, prediction logic can be used to predict an outcome of any first type of instruction flow changing instruction that is conditional, and the content of the return stack can be used to predict the return address in the event that the prediction logic predicts that that first type of instruction flow changing instruction will be executed. This enables the prefetch unit to retrieve as a next instruction the instruction which is predicted to be required by the processor upon execution of that first type of instruction flow changing instruction.

The prediction logic may take a variety of forms. In one embodiment, the prediction logic may be static prediction logic which is arranged to make a prediction about the likely outcome of an instruction flow changing instruction only using information in the instruction itself. In practice, this usually means using characteristics like the direction of the change in instruction flow to make a prediction. As an example, backwards changes in instruction flow (i.e. changes in instruction flow that cause a return to an instruction with a lower address) are typically found at the end of loops and are therefore generally considered to be taken more times than not taken, whereas forwards changes in instruction flow (i.e. changes that move to an instruction with a higher address) have a more likely probability of not being taken. Therefore, it is common that static prediction logic is arranged to predict backwards changes in instruction flow as taken, and forwards changes in instruction flow as not taken.

However, in one embodiment, the branch prediction logic is a dynamic prediction logic which is operable to provide a prediction as to whether the prefetched instruction will be executed by the processor dependent upon history information identifying an outcome of conditional instructions previously executed by the processor. It has been found that dynamic branch prediction can provide accurate prediction for instruction flow changing instructions that include instructions of the first type of instruction flow changing instruction, for example procedure return instructions.

It will be appreciated that prediction logic can be located at any suitable location within the data processing apparatus. However, in one embodiment, the prediction logic is provided within the prefetch unit. Similarly, the return stack can be located at any appropriate position, provided that it is accessible by the prefetch unit. However, in one embodiment, the return stack is provided within the prefetch unit.

The prefetch unit can be arranged in a variety of ways. However, in one embodiment, the prefetch unit comprises decode logic operable to determine for the prefetched instruction whether that prefetched instruction is an instruction flow changing instruction, and control logic operable in response to the decode logic to determine the fetch address for the next instruction to be prefetched by the prefetch unit.

Viewed from a second aspect, the present invention provides a method of operating a data processing apparatus comprising a processor operable to execute instructions, a prefetch unit operable to prefetch instructions from a memory prior to sending those instructions to the processor for execution, and a return stack accessible by the prefetch unit and operable to hold one or more addresses, the method comprising the steps of: (a) determining for a prefetched instruction whether that prefetched instruction is an instruction flow changing instruction, and based thereon determining a fetch address for a next instruction to be prefetched by the prefetch unit; (b) if the prefetched instruction is a conditional instruction, predicting whether that prefetched instruction will be executed by the processor, and at said step (a) determining the fetch address dependent on the prediction; and (c) in the event that the prefetched instruction is a first type of instruction flow changing instruction and is conditional, and if said step (b) predicts that that prefetched instruction will be executed, determining as the fetch address an address obtained from the return stack.

### BRIEF DESCRIPTION OF THE DRAWINGS

The present invention will be described further, by way of example only, with reference to preferred embodiments thereof as illustrated in the accompanying drawings, in which:

FIG. 1 is a block diagram illustrating a data processing apparatus connected to a memory in accordance with one embodiment of the present invention;

FIG. 2 is a block diagram illustrating the operation of the dynamic branch predictor of FIG. 1;

FIG. 3 schematically illustrates the operation of a return stack in accordance with one embodiment of the present invention;

FIGS. 4A and 4B are flow diagrams illustrating processing performed within the prefetch unit in accordance with one embodiment of the present invention;

FIG. 5A is a flow diagram illustrating certain processing performed within the processor core when receiving a procedure return instruction that the prefetch unit has predicted as not being executed; and

FIG. 5B is a flow diagram illustrating certain processing performed within the processor core when receiving a procedure return instruction that the prefetch unit has predicted as being executed.

### DESCRIPTION OF PREFERRED EMBODIMENTS

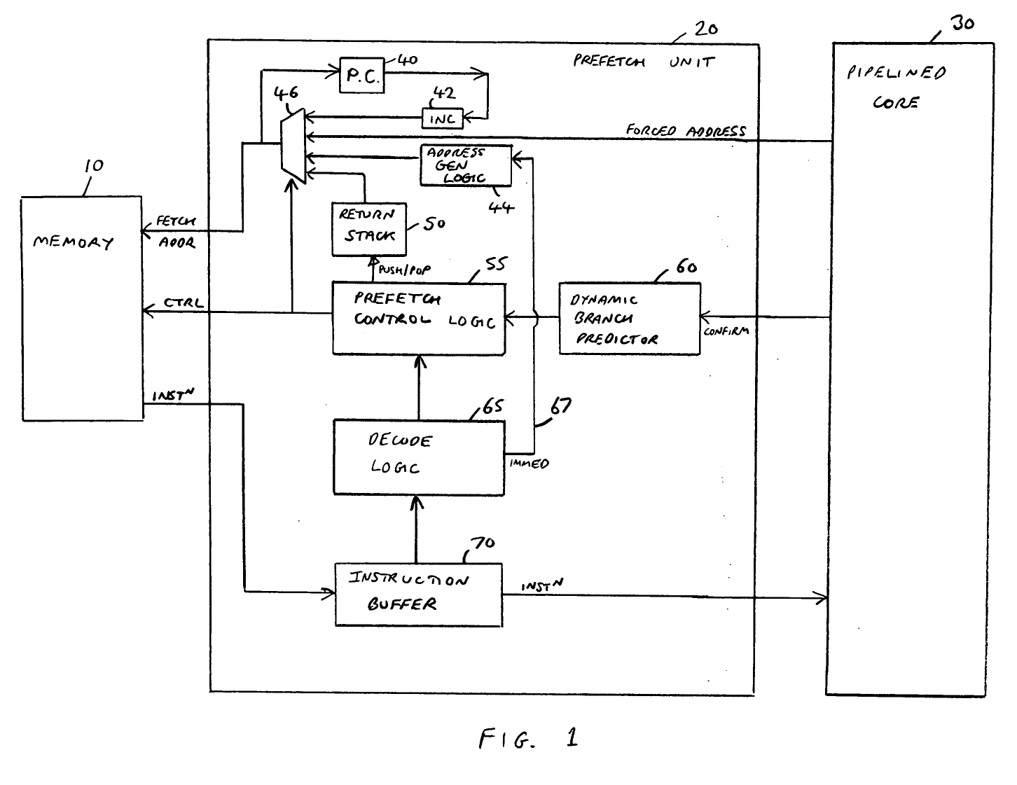

FIG. 1 is a block diagram of a data processing apparatus connected to a memory 10 in accordance with one embodiment of the present invention. The data processing apparatus includes a pipelined core 30 having a pipelined execution unit for executing instructions. The prefetch unit 20 is arranged to prefetch instructions from memory 10 that are required by the pipelined processor core 30, with the aim of ensuring that the processor core 30 has a steady stream of instructions to execute, thereby aiming to maximise the performance of the processor core 30.

Prefetch control logic 55 is arranged to issue control signals to the memory 10 to control the fetching of instructions from the memory, whilst in addition providing a control signal to the multiplexer 46 to cause a fetch address to be output to the memory 10 identifying the address of the instruction to be prefetched. The prefetched instruction is then returned from the memory 10 to the instruction buffer 70, from where it is then output from the prefetch unit to the core 30. At any particular point in time, there will typically be a plurality of instructions within the instruction buffer 70 waiting to be sent to the core 30 as and when required by the core. The instruction buffer 70 typically is arranged to act as a First-In-First-Out (FIFO) buffer.

Decode logic 65 is provided within the prefetch unit 20, and is operable for each prefetched instruction in the instruction buffer to partially decode that instruction in order to determine whether that prefetched instruction is an instruction flow changing instruction. This will typically be done by analysing certain bits of the opcode of the instruction in order to determine the instruction type. The decode logic 65 may be arranged to detect a number of different types of instruction flow changing instruction. In one particular embodiment, the decode logic 65 is arranged to partially decode each prefetched instruction in order to determine whether it is a branch instruction, a branch with link instruction, or a procedure return instruction. There are a number of different procedure return instructions that may be used to cause the processor to return from a procedure that is currently executing, and accordingly in some embodiments of the present invention the decode logic 65 will analyse the prefetched instruction to determine from various bits of the opcode whether that instruction is one of a number of different versions of a procedure return instruction. In one particular embodiment, the decoded logic may look for the following types of procedure return instruction:
1) MOV PC,R14
2) BX R14
3) LDMR13, {PC, . . . }
4) LDRPC, [R13]
5) POP

The first four above instructions are from the ARM instruction set developed by ARM Limited. The move instruction “MOV” is arranged to update the program counter (PC) value with the contents of the register R14. Hence, when this instruction is used, the register R14 will previously be loaded with the return address required when returning from the procedure being executed by the processor. The branch exchange instruction “BX” branches to the address stored in the register R14, and may also cause a change in instruction set to take place. The two types of load instruction “LDM” and “LDR” are both arranged to obtain from memory the data identified by an address stored in the register R13 and to then use that data as the new PC value. Hence, when these versions of procedure return instruction are used, the return address will previously have been stored to memory, with its location in memory being stored within the register R13. Finally, the POP instruction is an instruction specified by the Thumb instruction set developed by ARM Limited, the Thumb instruction set comprising 16-bit instructions. The POP instruction performs a similar function to the specific move instruction “MOV” discussed earlier.

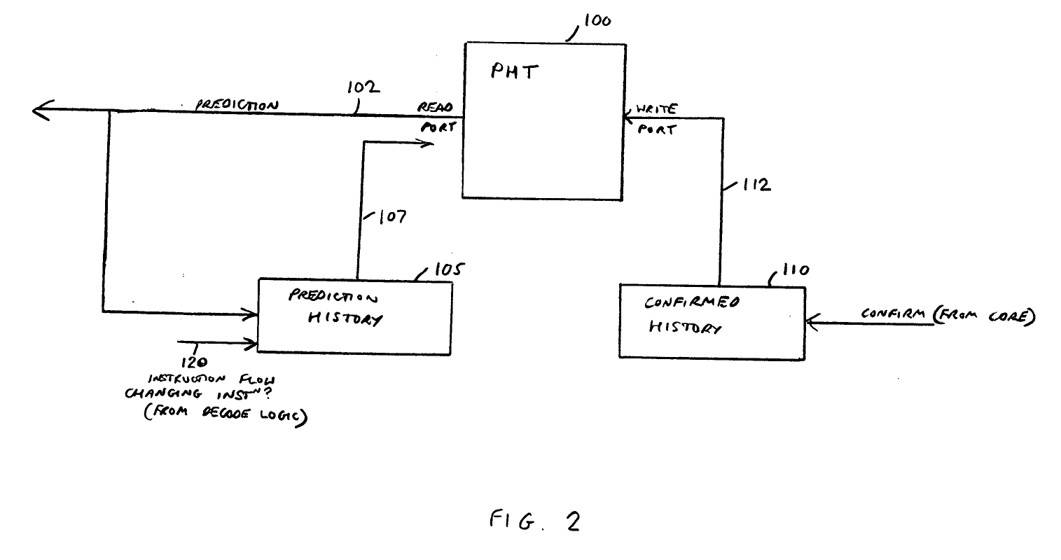

When the decode logic has analysed the prefetched instruction, it outputs a control signal to the prefetch control logic 55 indicative of the results of that analysis. This information is used by the prefetch control logic when determining which of the various inputs to the multiplexer 46 should be output as the fetch address for the next instruction to be prefetched by the prefetch unit 20. The prefetch control logic 55 is also arranged to receive a signal from the dynamic branch predictor 60 which, for conditional instructions, is arranged to provide an indication as to whether the instruction is predicted as being taken (i.e. executed) or not taken. As will be discussed in more detail with reference to FIG. 2, the dynamic branch predictor 60 is provided with a confirm signal from the core 30, giving history information about the outcome of previously executed conditional instructions, this history information being used to update information maintained by the dynamic branch predictor and used to make future predictions.

The dynamic branch predictor 60 can be arranged to output a signal to the prefetch control logic every cycle, but in that instance the prefetch control logic 55 is only arranged to consider the signal that it receives from the dynamic branch predictor 60 in instances where the decode logic 65 has identified that the prefetched instruction being analysed by the decode logic is a conditional instruction flow changing instruction.

With regards to the inputs to the multiplexer 46, a current PC value is stored in register 40, which receives its input from the output of the multiplexer 46. The output from the register 40 is then fed to an incrementer 42 which then provides an incremented version of the PC value as an input to the muliplexer 46. Address generation logic 44 is arranged to receive an immediate value from decode logic 65 in situations where the decode logic 65 identifies either a branch instruction or a branch with link instruction containing an immediate value. Both the branch instruction and the branch with link instruction may specify within the instruction an immediate value, also referred to herein as an offset value, which when added to the address of that instruction (in some cases along with a predetermined constant value) will give an indication of the target address for the next instruction required by the processor should that branch or branch with link instruction be executed by the processor. The address generation logic 44 has access to the address of each instruction analysed by the decode logic, and if provided with an immediate value over path 67 performs this addition and then provides the generated target address as an input to the multiplexer 46.

A return stack 50 is also provided within the prefetch logic, and is arranged as a push/pop stack which is controlled by the prefetch control logic 55. Each time the decode logic identifies a branch with link instruction, the prefetch control logic is arranged to push a return address onto the return stack 50, the return address typically being determined by incrementing the address of the branch with link instruction. When a procedure return instruction is identified by the decode logic 65, the prefetch control logic 55 is then arranged to cause an address from the return stack to be popped from the return stack and output as an input to the multiplexer 46, in this instance the prefetch control logic 55 also sending a control signal to the multiplexer 46 to cause the address popped from the return stack to be output as the fetch address to memory 10. Through this mechanism, the prefetch unit is able, in situations where the decode logic has identified a procedure return instruction, and the dynamic branch predictor 60 has predicted that that procedure return instruction will be executed (or the procedure return instruction is unconditional), to predict a return address with reference to the return stack, and accordingly retrieve the instruction at that predicted return address from memory. In situations where the prediction is correct, this will provide a significant performance improvement of the pipelined core 30. However, the pipelined core 30 will ultimately need to determine that the prediction made by the dynamic branch predictor 60 is correct, and in the event that it is correct will also need to check that the predicted return address determined with reference to the return stack 50 is also correct.

In situations where the pipelined core subsequently determines that any prediction made by the prefetch unit, whether that relates to a branch instruction, a branch with link instruction, or a procedure return instruction, is inaccurate, then it will typically calculate the address for the instruction that is required next by the core, and will output that address as a forced address back to the prefetch unit 20, this forced address being input to the multiplexer 46. In that instance, the prefetch control logic 55 will cause the multiplexer 46 to output as the fetch address the forced address returned from the pipelined core 30. Further, the current contents of the instruction buffer 70 will typically be flushed, such that when the required instruction is returned from memory, that instruction can be output to the pipelined core 30.

The dynamic branch predictor logic 60 of FIG. 1 is arranged to operate in a known manner, as will be briefly be discussed with reference to FIG. 2. However, in addition to receiving history information about the outcome of branch and branch with link instructions, the dynamic branch predictor logic 60 will also receive history information concerning the outcome of any procedure return instructions that are conditional. The dynamic branch predictor 60 includes a Pattern History Table (PHT), which identifies for a particular index whether a prediction of “taken” or “not taken” should be output. In a known manner, the confirmed history 110 for a number of preceding conditional instructions, for example eight preceding instructions, is maintained by the dynamic branch predictor 60 using outcome information returned from the core 30, and then sent over path 112 to a write port of the PHT 100 to cause the contents of the PHT to be updated.

Also as known, a prediction history 105 is maintained by the dynamic branch predictor 60, which is updated each time the decode logic 65 determines that a conditional instruction flow changing instruction has been detected. In that instance, an appropriate control signal (e.g. a logic one value) is received by the prediction history logic 105 over path 120, in order to cause a current prediction over path 102 to be loaded into the prediction history 105. The prediction history will maintain details of the predictions made for a certain number of preceding instruction flow changing instructions analysed by the decode logic 65, for example eight instruction flow changing instructions, and that prediction history will be used to generate an index over path 107 in order to access the PHT 100. As a result of accessing the PHT 100 with the index provided over path 107, a prediction will be output over path 102 from the dynamic branch predictor 60 to the prefetch control logic 55. It will be noted that, at any point in time, the conditional instructions on which the prediction history 105 is based will be different to the conditional instructions on which the confirmed history 110 is based, due to the time delay between analysis of a conditional instruction by the decode logic 65, and the passage of that instruction through the execution pipeline of the core 30.

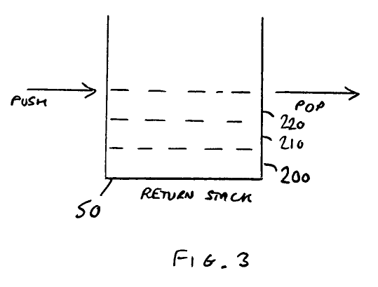

FIG. 3 schematically illustrates the return stack 50 of FIG. 1. The return stack 50 shown in FIG. 3 has three entry locations 200, 210, 220 for receiving return addresses pushed onto the return stack under the control of the prefetch control logic 55. Return addresses are popped from the return stack in accordance with a “First In Last Out” policy.

As a result, it can be seen that if a branch with link instruction is detected by the decode logic, thus causing a return address to be pushed onto the return stack 50, and that branch instruction is then subsequently executed by the processor, then if the first instruction subsequently executed by the processor that is detected as a procedure return instruction is in fact the procedure return instruction for the procedure identified by the branch with link instruction, then provided the prefetch unit has predicted that procedure return instruction as being executed, the information obtained from the return stack will have provided an accurate address for the instruction now required by the processor core.

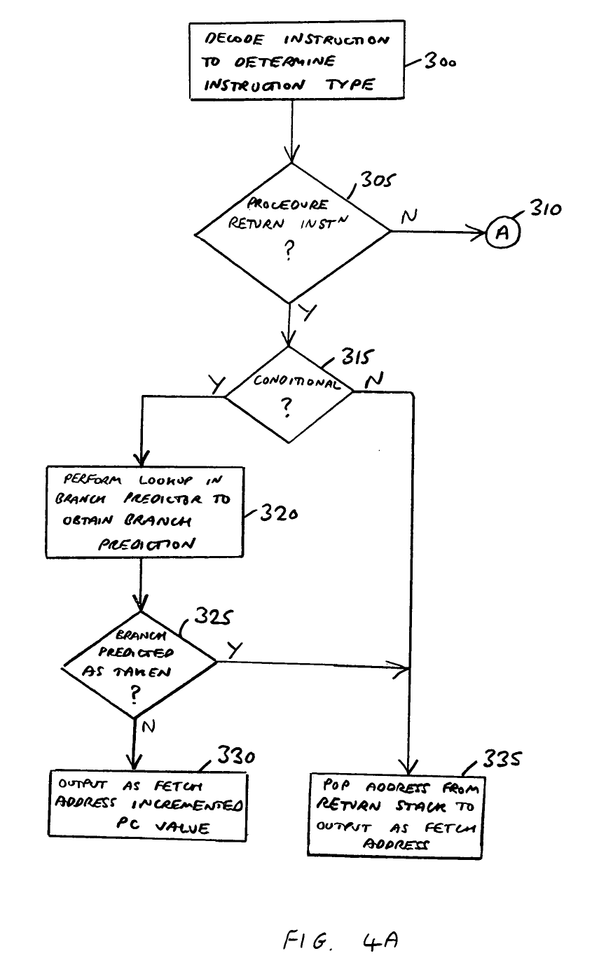

FIGS. 4A and 4B are flow diagrams illustrating processing performed within the prefetch unit 20 in accordance with one embodiment of the present invention. At step 300, the decode logic 65 partially decodes the instruction in order to determine the instruction type. Then, at step 305 it is determined whether the instruction is a procedure return instruction. If so, the process proceeds to step 315, where it is determined whether that procedure return instruction is a conditional instruction. These steps will typically be performed by the decode logic 65, and will result in the issuance of appropriate control signals to the prefetch control logic 55.

If at step 315 it is determined that the instruction is conditional, then at step 320 a look up will be performed in the branch predictor 60 in order to obtain a branch prediction which will be input to the prefetch control logic 55. Then, at step 325, the prefetch control logic 55 will determine whether the branch is predicted as taken. If not, then at step 330 the prefetch control logic 55 will control the multiplexer 46 to output as the fetch address the incremented PC value as received from the increment logic 42. However, if the branch is predicted as taken at step 325, or the instruction is determined not to be conditional at step 315, the process proceeds to step 335, where the prefetch control logic 55 causes an address to be popped from the return stack 50, and for the multiplexer 46 to then output that popped address as the fetch address.

If at step 305, it is determined that the currently analysed prefetched instruction is not a procedure return instruction, then the process branches to FIG. 4B, where at step 400 it is determined whether the instruction is a branch with link (BL) instruction. If the instruction is a BL instruction, then the process proceeds to step 410, where it is determined whether that instruction is a conditional instruction. The steps 400, 410 are performed within the decode logic 65, and cause appropriate control signals to be issued to the prefetch control logic 55.

If the instruction is determined at step 410 to be conditional, then the process proceeds to step 415, where a look up is performed in the branch predictor 60 in order to obtain a branch prediction, which is then input to the prefetch control logic 55. At step 420, the prefetch control logic 55 then determines whether the branch is predicted as taken, and if not, controls the multiplexer 46 to output as the fetch address the incremented PC value received from the incrementer 42.

However, if at step 420 it is determined that the branch is predicted as taken, or if at step 410 it is determined that the instruction is not conditional, the process proceeds to step 425 where an incremented version of the address of the BL instruction decoded at step 300 is pushed onto the return stack 50. Thereafter, the process proceeds to step 450, where an immediate value decoded from the BL instruction is added by address generation logic 44 to the address of the BL instruction to produce a target address which is then output via the multiplexer 46 as the fetch address.

If at step 400 it is determined that the instruction is not a BL instruction, then it is determined at step 405 whether the instruction is a branch (B) instruction. If the instruction is a B instruction, then the process proceeds to step 435, where it is determined whether that instruction is conditional. Again, steps 405 and 435 are performed within the decode logic 65 and result in appropriate control signals being issued to the prefetch control logic 55.

If the instruction is determined to be conditional then the process proceeds to step 440, where a look up is performed with the branch predictor 60 in order to obtain a branch prediction, whereafter at step 445 the prefetch control logic 55 determines whether the branch is predicted as taken. If not, then the process proceeds to step 430, where the incremented PC value from the incrementer 42 is output as the fetch address. However, if the branch is predicted as taken at step 445, or if at step 435 it is determined that the branch instruction is not conditional, then the process proceeds to step 450, where an immediate value is added to the address of the B instruction by address generation logic 44 in order to generate a fetch address to be output via the multiplexer 46.

If at step 405, it is determined that the instruction is not a branch instruction, then in the above described embodiment of the present invention, this means that the prefetched instruction is not an instruction flow changing instruction, and in that instance the process proceeds directly to step 430, where the incremented PC value from incrementer 42 is output as the fetch address.

When a procedure return instruction is output from the instruction buffer 70 to the processor core 30, the prefetch unit will also provide to the core an indication as to whether that procedure return instruction was predicted as being taken or not taken. In addition, if the prefetch unit has predicted the instruction as being taken, the prefetch unit provides the fetch address that was popped from the return stack. Further, in this instance, the prefetch unit will also provide to the processor core 30 a recover-PC address comprising an incremented address calculated by incrementing the address of the procedure return instruction, as this address will be needed if it is later determined that the instruction should in fact not be executed. As will be appreciated by those skilled in the art, a recover-PC value will be associated with each instruction as it moves through the processor core, and represents an address which can be used in the event that the prediction is determined to be incorrect, i.e. it provides an indication of the opposite outcome to that predicted by the prefetch unit.

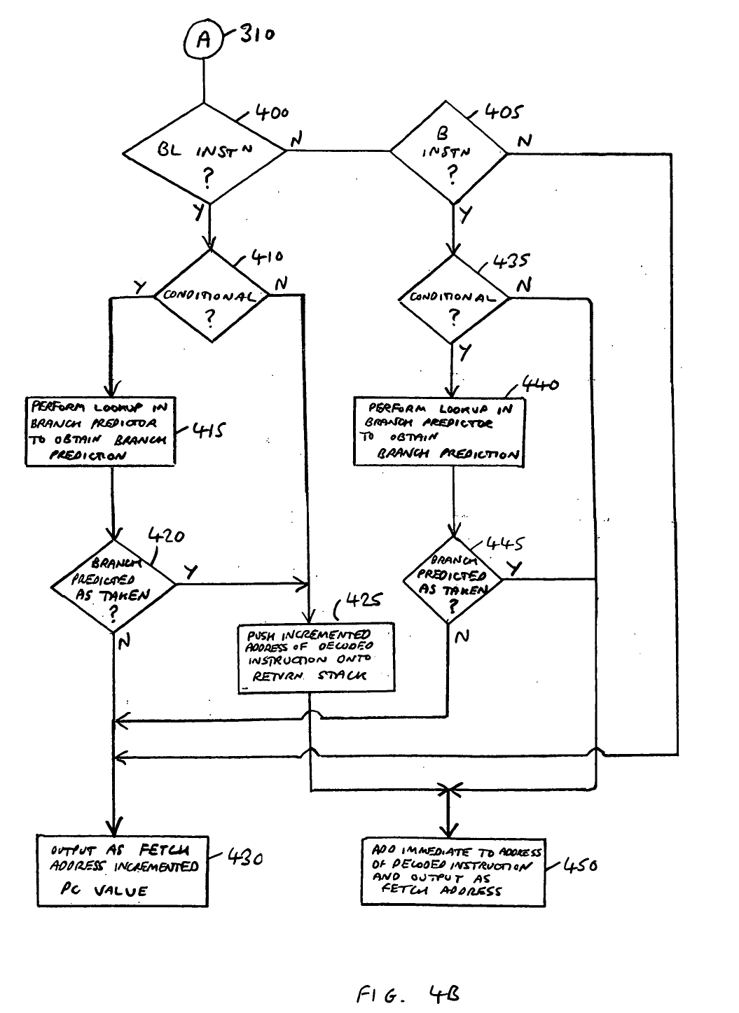

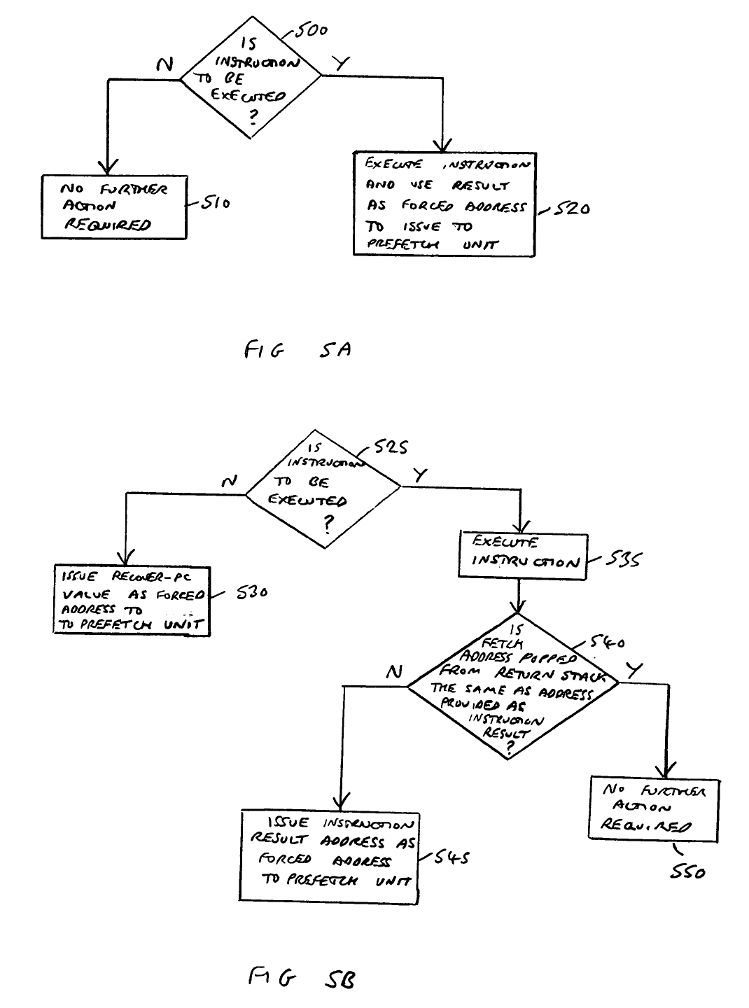

FIG. 5A is a flow diagram illustrating certain processing performed within the processor core when receiving a procedure return instruction that the prefetch unit has predicted as not being executed. At step 500, the processor core will determine whether the procedure return instruction should in fact be executed, this being done by checking of the appropriate condition codes. If it is determined that the instruction should not be executed, i.e. the prediction was correct, then the process proceeds to step 510, where no further action is required. However, if at step 500 it is determined that the instruction should be executed, then the process proceeds to step 520, where the instruction is executed, and the result is used as a forced address to issue to the prefetch unit. This will then cause the prefetch unit to prefetch the instruction that is next required by the processor core, and to then route that instruction back to the processor core.

FIG. 5B is a flow diagram illustrating certain processing performed by the processor core when receiving a procedure return instruction that the prefetch unit has predicted as being executed. At step 525, it is determined whether the instruction is to be executed, again this being done by checking the appropriate condition codes. If it is determined that the instruction should not be executed, i.e. the prediction was wrong, then at step 530 the recover-PC value is issued as the forced address to the prefetch unit.

If at step 525, it is determined that the instruction is to be executed, then the instruction is executed at step 535. However, additionally, as the fetch address popped from the return stack is only a prediction of the target address, then at step 540 an additional check is performed to check whether the fetch address popped from the return stack is the same as the address provided as the instruction result. If it is, then the process proceeds to step 550, where no further action is required. However, if it is determined that the fetch address is different to the result of the instruction, then the process proceeds to step 545, where the address produced as a result of the instruction's execution is output as a forced address to the prefetch unit. This will cause the prefetch unit 20 to retrieve the required instruction from memory, from where it can be routed to the processor core.

From the above discussion of an embodiment of the present invention, it will be appreciated that the prefetch unit 20 of embodiments of the present invention provides for prediction of the outcome of more types of instruction flow changing instruction than previously could be predicted. In particular, for procedure return instructions, which are an example of an indirect instruction flow changing instruction, a prediction can be made as to whether a conditional procedure return instruction will be executed, and in the event that it is predicted that the instruction will be executed, the prefetch unit can also predict the return address through reference to the return stack. Accordingly the prefetch unit 20 can prefetch an instruction which is predicted to be the instruction that will be required by the processor core 30 once the procedure return instruction has been executed by the processor core. This provides a significant improvement in performance of the processor core in situations where an appropriate accuracy in the prediction by the prefetch unit can be achieved to make any extra checking step required by the core (e.g. step 540 of FIG. 5B) worthwhile.

Although a particular embodiment of the invention has been described herein, it will be apparent that the invention is not limited thereto, and that many modifications and additions may be made within the scope of the invention. For example, various combinations of the features of the following dependent claims could be made with the features of the independent claims without departing from the scope of the present invention.

1. A data processing apparatus, comprising:
a processor operable to execute instructions;
a prefetch unit operable to prefetch instructions from a memory prior to sending those instructions to the processor for execution, the prefetch unit being operable to determine for a prefetched instruction whether that prefetched instruction is an instruction flow changing instruction, and based thereon to determine a fetch address for a next instruction to be prefetched by the prefetch unit;
a return stack accessible by the prefetch unit and operable to hold one or more addresses; and
prediction logic operable, if the prefetched instruction is a conditional instruction, to predict whether that prefetched instruction will be executed by the processor, the prefetch logic being operable to determine the fetch address dependent on the prediction from the prediction logic;
in the event that the prefetched instruction is a first type of instruction flow changing instruction and is conditional, and the prediction logic predicts that that prefetched instruction will be executed, the prefetch logic being operable to determine as the fetch address an address obtained from the return stack.

2. A data processing apparatus as claimed in claim 1, wherein the first type of instruction flow changing instruction is a procedure return instruction operable when executed to cause the processor to return from a procedure being executed by the processor.

3. A data processing apparatus as claimed in claim 1, wherein if the prefetch logic determines that the prefetched instruction is a second type of instruction flow changing instruction, the prefetch logic is further operable to determine a return address and to cause that return address to be placed on the return stack.

4. A data processing apparatus as claimed in claim 3, wherein said second type of instruction flow changing instruction is a branch with link instruction, which is operable to identify a start address for a procedure to be executed by the processor, upon returning from the procedure the next instruction to be executed by the processor being specified by the return address.

5. A data processing apparatus as claimed in claim 4, wherein the procedure is returned from by execution of one of said first type of instruction flow changing instructions.

6. A data processing apparatus as claimed in claim 1, wherein said prediction logic is a dynamic prediction logic which is operable to provide a prediction as to whether the prefetched instruction will be executed by the processor dependent upon history information identifying an outcome of conditional instructions previously executed by the processor.

7. A data processing apparatus as claimed in claim 1, wherein said prediction logic is provided within said prefetch unit.

8. A data processing apparatus as claimed in claim 1, wherein said return stack is provided within said prefetch unit.

9. A data processing apparatus as claimed in claim 1, wherein said prefetch unit comprises decode logic operable to determine for the prefetched instruction whether that prefetched instruction is an instruction flow changing instruction, and control logic operable in response to the decode logic to determine the fetch address for the next instruction to be prefetched by the prefetch unit.

10. A method of operating a data processing apparatus comprising a processor operable to execute instructions, a prefetch unit operable to prefetch instructions from a memory prior to sending those instructions to the processor for execution, and a return stack accessible by the prefetch unit and operable to hold one or more addresses, the method comprising the steps of:
(a) determining for a prefetched instruction whether that prefetched instruction is an instruction flow changing instruction, and based thereon determining a fetch address for a next instruction to be prefetched by the prefetch unit;
(b) if the prefetched instruction is a conditional instruction, predicting whether that prefetched instruction will be executed by the processor, and at said step (a) determining the fetch address dependent on the prediction; and
(c) in the event that the prefetched instruction is a first type of instruction flow changing instruction and is conditional, and if said step (b) predicts that that prefetched instruction will be executed, determining as the fetch address an address obtained from the return stack.

11. A method as claimed in claim 10, wherein the first type of instruction flow changing instruction is a procedure return instruction operable when executed to cause the processor to return from a procedure being executed by the processor.

12. A method as claimed in claim 10, wherein if at said step (a) it is determined that the prefetched instruction is a second type of instruction flow changing instruction, the method further comprises the steps of:
determining a return address; and
placing that return address on the return stack.

13. A method as claimed in claim 12, wherein said second type of instruction flow changing instruction is a branch with link instruction, which is operable to identify a start address for a procedure to be executed by the processor, upon returning from the procedure the next instruction to be executed by the processor being specified by the return address.

14. A method as claimed in claim 13, further comprising the step of returning from the procedure by execution of one of said first type of instruction flow changing instructions.

15. A method as claimed in claim 10, wherein said step (b) comprises the step of providing a prediction as to whether the prefetched instruction will be executed by the processor dependent upon history information identifying an outcome of conditional instructions previously executed by the processor.

16. A method as claimed in claim 10, wherein said step (b) is performed within said prefetch unit.

17. A method as claimed in claim 10, wherein said return stack is provided within said prefetch unit.

18. A method as claimed in claim 10, wherein said prefetch unit comprises decode logic operable to determine for the prefetched instruction whether that prefetched instruction is an instruction flow changing instruction, and control logic operable in response to the decode logic to determine the fetch address for the next instruction to be prefetched by the prefetch unit.
